(19) United States
(12) Patent Application Publication
(10) Pub. No.: US 2021/0234443 A1
(43) Pub. Date: Jul. 29, 2021

(54) METHOD FOR PRODUCING COMPRESSED STRAND, METHOD FOR PRODUCING AN ELECTRIC MOTOR, AND USE OF COMPRESSED STRAND

(71) Applicant: JHEECO E-DRIVE AG, Eschen (LI)

(72) Inventor: Martin STÖCK, Salez (CH)

(21) Appl. No.: 17/059,338

(22) PCT Filed: May 21, 2019
(86) PCT No.: PCT/EP2019/063037

§ 371 Date: Nov. 27, 2020

(30) Foreign Application Priority Data
May 28, 2018 (DE) 10 2018 208 407.6

(51) Int. Cl. H02K 15/04

(52) U.S. Cl. CPC H02K 15/0428

(57) ABSTRACT

The invention relates to a method for producing a compressed strand (F) made of an insulated wire (1) which is supplied in a straight manner or in a substantially straight manner, characterized by the following method steps: a) shaping the insulated wire (1) into at least one half-loop, ring, or coil using a shaping device (2); b) twisting the at least one half-loop, ring, or coil into a wire packet (D) using a twisting device (4); c) compacting the wire packet (D) using a compacting device (5), as well as to a method for producing an electric motor, where at least a portion of the compressed strand for the electric motor is produced using the method according to the invention, and to the use of the compressed strand in the stator (S) of an electric motor, where the compressed strand is at least in sections the compressed strand produced according to the invention.

The present invention relates to a method for producing compressed strand according to claim 1, a method for producing an electric motor according to claim 10, as well as the use of compressed strand according to claim 11 as well as compressed strand according to claim 12.

Compressed strands are litz wires, i.e. twisted or untwisted tufts of wire, which are compacted and thus given a certain cross-sectional shape, typically a rectangular cross-sectional shape.

Compressed strands can be used as Milliken conductors in electrical machines, in particular in stators. Milliken conductors are conductor sections which are e.g. inserted or drawn into stator slots. The protruding ends of two compressed strands can then be connected directly to form half-coils. The half-coils are likewise connected by being connected accordingly on the oppositely disposed side of the stator. Different winding patterns can be implemented, e.g. a concentrated winding or—of particular interest—a wave winding. Wave winding means that ultimately (three) continuous strands of conductor meander around the stator slots. In the case of a three-phase machine, this is known, for example, from U.S. Pat. No. 9,035,526B2 or DE10113831B4.

Insulated wire, in particular varnished wire, is preferably used as the wire for compressed strands.

In the end sections (compressed strand heads), the individual wires are electrically and mechanically connected to one another for the purpose of further contacting. This is done e.g. with ultrasonic or electrode welding, where a sleeve is typically used. Insulating varnish of the wires present in the compressed strand head is always in part burned away and in part squeezed out.

The connection of two compressed strands can be effected directly, e.g. by welding two compressed strand heads. For this purpose, the compressed strand heads are sleeved, in particular a sleeve is pressed or welded thereonto. There are two reasons for this, firstly, to create a defined connection surface for welding, secondly, to connect the wire ends in the compressed strand head electrically and mechanically to one another. Examples for this are given e.g. in EP3051669A1.

The drawback is the high complexity of a production system, e.g. stranding systems that produce a compressed strand or a compressed strand blank.

This is where the present invention comes in and proposes an improved method for producing a compressed strand, in particular proposes a method that overcomes the aforementioned drawbacks, preferably proposing a method for producing a compressed strand that provides a reliable electrical and mechanical interconnection of the individual wires in a compressed strand head, possibly, with a sleeve.

This above object is satisfied by a method according to claim 1. Further features and details of the invention arise from the dependent claims, the description, and the drawings. Features and details described in the context of the method of course also apply in the context of the devices described and vice versa, so that reference is or can always be made to either with regard to the disclosure of the individual aspects of the invention.

An insulated wire typically supplied from a reel is first shaped in a shaping device to at least one half-loop, a ring or a coil. Only a single wire can be used. Synchronization of a plurality of wires can be omitted. Furthermore, a complex stranding system can be dispensed with. In principle, the work step of trimming or cutting off the end of the compressed strand can be omitted. Since the wire sections in the head end are to be electrically connected to one another anyway, the loops present in the head are no hindrance, but are even advantageous. After shaping, the coil or the at least one ring or half-loop can be twisted and correspondingly compacted. Compacting is preferably carried out in a compacting device, where the twisted wire packet is pressed in a compacting process to form the compressed strand with a defined outer contour. The electrical and mechanical connection of the individual wires of the compressed strand in the head area can then be effected using a method known from prior art, possibly employing sleeves.

Further advantageous configurations of the proposed invention arise in particular from the features of the dependent claims. The objects or features of the various claims can in principle be combined with one another at random.

It can be provided in an advantageous embodiment of the invention that shaping is carried out in a shaping device designed as a winding holder. A winding holder generally comprises two or four fingers arranged in parallel and is optionally equipped with or without an axis of rotation. The wire can be wound or pushed in the manner of a reel and be shaped there. Such a configuration is particularly suitable for shaping the wire to at least one ring or a coil, where the shape substantially depends on the spacing and configuration of the fingers, but should basically come close to a rectangle with preferably rounded corners, in particular since this structure is to be twisted to an elongate compressed strand in a subsequent process step. In this respect, essentially two long sides and two short sides arise for the coil, but also for the ring. An embodiment with only one finger is also conceivable and is essentially suitable for shaping a wire there into a half-loop. In this case, two long sides and one short side connecting the two long sides arise accordingly.

It was also recognized as a disadvantage that the insulation layer applied around the individual wire is an obstacle to the connection method of the individual wires in the compressed strand head and, due to varnish residues, is likewise an obstacle to the connection process of two compressed strand heads to one another, in particular due to the development of smoke, leakage of residues of insulation varnish from the compressed strand head, unreliable connection due to an undefined quantity and distribution of residues of the insulation varnish in the compressed strand head etc.

In particular, the locally limited evaporation of the insulating varnish of the individual wires has been proposed for both individual production (batch production) and continuous production (as continuous wire). The problem there is the synchronization of the individual wires so that the sections of the individual wires locally stripped of insulation come to lie flush on top of one another.

In an advantageous configuration of the invention, the wire or the half-loop, ring, or coil is partially stripped of insulation using an insulation stripping device, where the partial stripping of insulation is performed after shaping and prior to shaping, in particular on the long sides or on the short sides between the fingers of a winding holder, or the partial stripping of the insulation is performed prior to shaping, in particular on the insulated wire supplied in a straight or substantially straight manner. In the context of the first variant, partially stripping the insulation is performed at a point in time at which the shape of the at least one half-loop, ring, or coil to be twisted has already been determined. It can be then ensured in a simple manner that the regions stripped of insulation are in the correct places, namely at the places at which the individual wires are to establish an electrical interconnection and possibly with a sleeve. Alternatively, however, partially stripping the insulation can also be performed prior to shaping, in particular on the insulated wire supplied in a straight or substantially straight manner.

Partially stripping insulation can preferably be done mechanically and/or abrasively, in particular by grinding and/or sandblasting, and/or chemically and/or thermally, in particular using cold embrittlement, laser sublimation, induction heating. This selection is not exhaustive. However, the aforementioned methods are suitable in a particularly advantageous manner for industrial use.

It can be provided in a further advantageous embodiment of the invention that twisting the at least one half-loop, ring, or coil is performed using a twisting device, where the twisting device comprises in particular a first gripper for the first distal end of the at least one half-loop, ring, or coil, and comprises in particular a second gripper for the second distal end of the at least one half-loop, ring, or coil, where the grippers are rotated in particular about or approximately about the longitudinal axis of the at least one half-loop, ring, or coil.

It can be provided in a further advantageous embodiment of the invention that the first gripper is formed by a first finger and the second gripper is formed by a second finger or a tong tool. Such a configuration of the twisting device is preferably suitable for twisting a half-loop. In particular, the open part of the half-loop can be gripped by the tong tool while the closed part can be gripped by the finger.

It can be provided in a further advantageous embodiment of the invention that the twisting device is integrated into the shaping device or shaping is performed in the shaping device, respectively. This measure serves to optimize the process in such a way that transferring the at least one half-loop, ring, or coil can be avoided. In this context, it can be provided, for example, that the shaping device, in particular the winding holder, is equipped with suitable mechanics such that the fingers can be pivoted in such a way that the at least one half-loop, ring, or coil that has been received on the fingers anyway can be twisted.

It can be provided in a further advantageous embodiment of the invention that the insulated wire and/or the wire packet is acted upon with a bonding varnish, at least in sections. The bonding varnish can mechanically affix individual wires to each other. This applies in particular to vibrations that occur during the passage of alternating current.

In a further advantageous embodiment of the invention, the mechanical and electrical connection of the wire sections in the head ends is established without sleeves.

A further object of the present invention is to propose an improved method for producing an electric motor.

According to the invention, this object is satisfied with a method according to claim 10. Due to the fact that the compressed strand used there has been produced according to the method of the invention, the advantages obtained there can be made use of for the construction of electric motors.

A further object of the present invention is to demonstrate advantageous use of the compressed strand produced according to the invention.

According to the invention, this object is satisfied with a use according to claim 11. The compressed strand produced according to the invention can preferably be used in the rotor or stator of an electric motor.

A further object of the present invention is to propose an improved compressed strand.

This object is satisfied according to the invention with a compressed strand having the characterizing features of claim 12.

Further features and advantages of the present invention will become apparent from the following description of preferred embodiments with reference to the accompanying figures, where

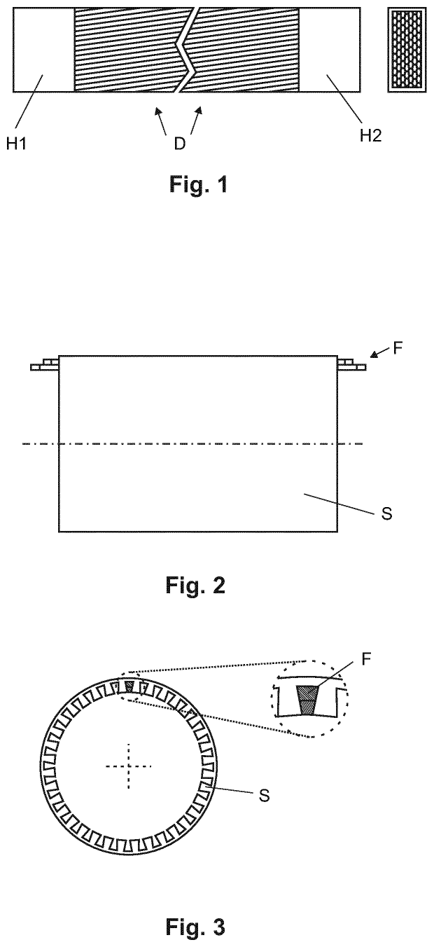

FIG. 1 shows a compressed strand produced according to the method of the invention;

FIG. 2 shows in a lateral view a stator of an electric motor, in particular an electric traction motor, e.g. for an automobile, with a compressed strand produced using the method according to the invention;

FIG. 3 shows in a face side view a stator of an electric motor, in particular an electric traction motor, e.g. for an automobile, with a compressed strand produced using the method according to the invention;

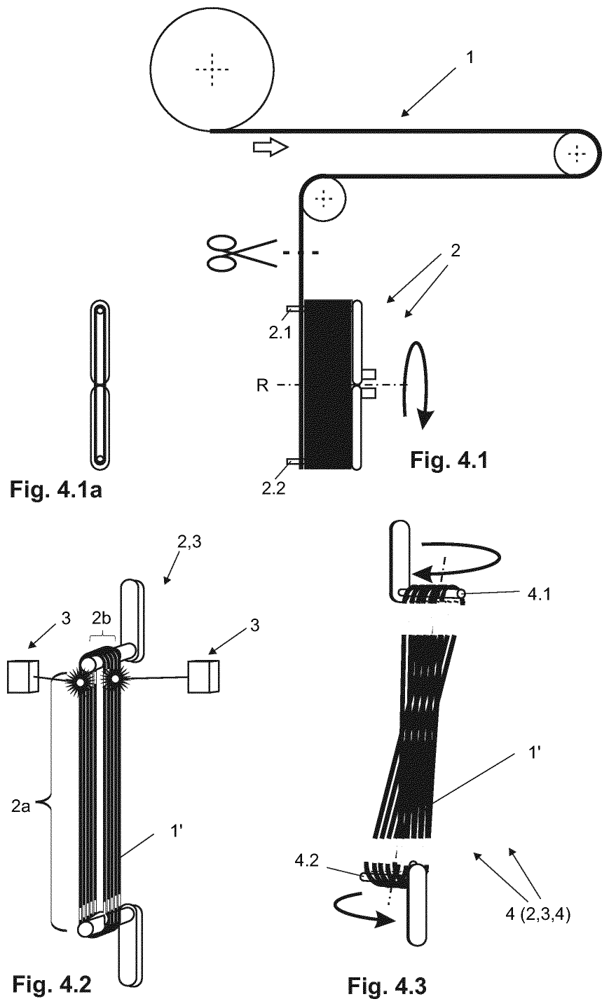

FIG. 4.1 shows the shaping of an insulated wire into a coil on a winding holder with two fingers;

FIG. 4.1a shows a top view onto the winding holder according to FIG. 4.1;

FIG. 4.2 shows the stripping of insulation from the wire on the winding holder according to FIGS. 4.1/4.1a;

FIG. 4.3 shows the twisting of the wire on the winding holder/twisting device;

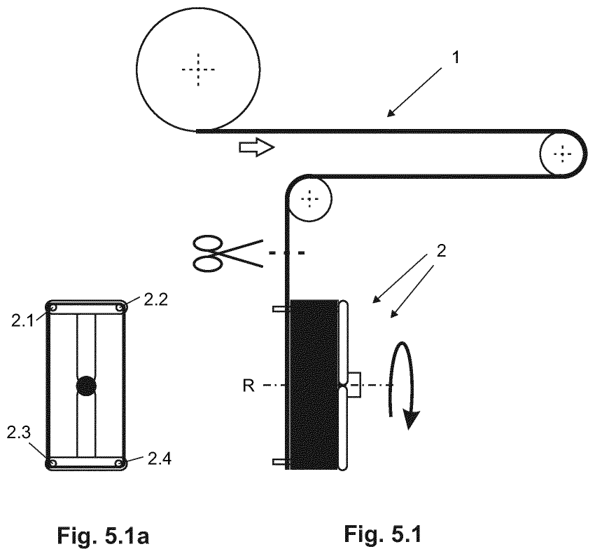

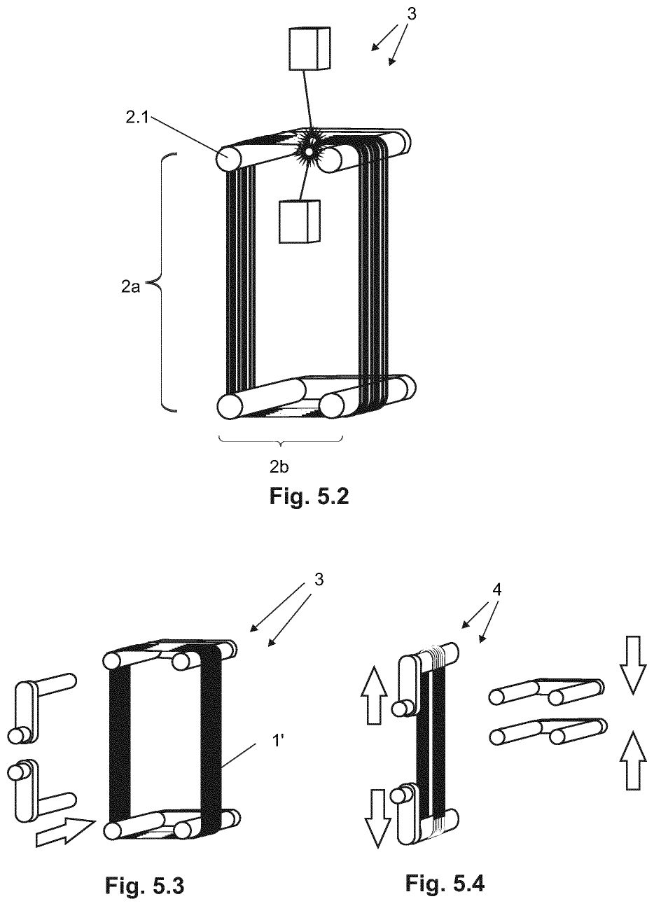

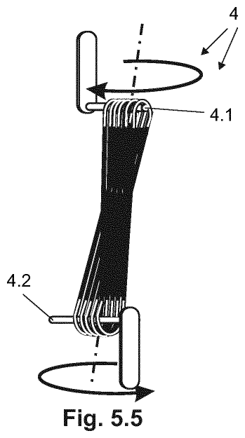

FIG. 5.1 shows the shaping of an insulated wire into a coil on a winding holder with four fingers;

FIG. 5.1a shows a top view onto the winding holder according to FIG. 5.1;

FIG. 5.2 shows the partial stripping of insulation from the coil on the winding holder according to FIG. 5.1/5.1a;

FIGS. 5.3/5.4 show the transfer of the coil from the four-finger winding holder to a two-finger winding holder;

FIG. 5.5 shows the twisting of the coil on the winding holder/twisting device;

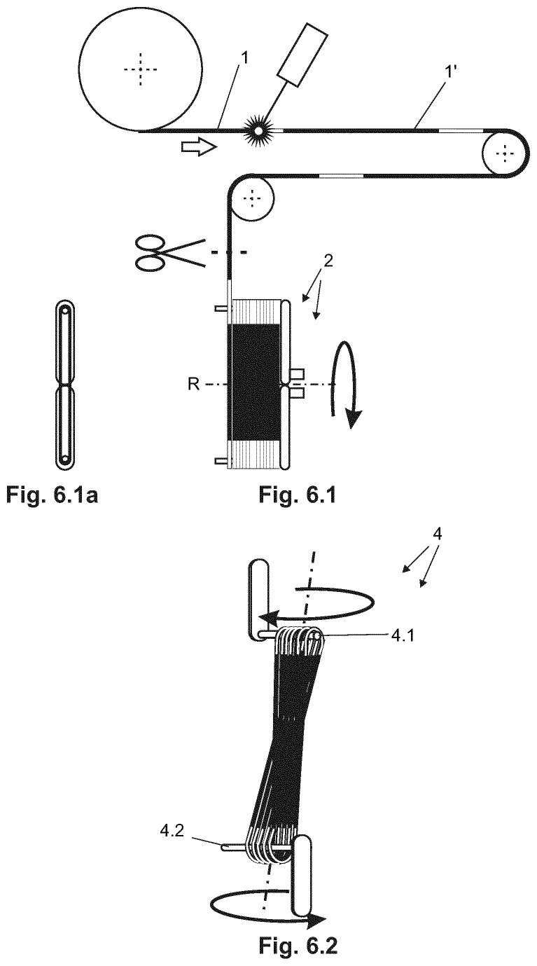

FIG. 6.1 shows the partial stripping of insulation from the insulated wire prior to shaping on a winding holder—shaping of a wire partially stripped of insulation into a coil on a winding holder with two fingers;

FIG. 6.1a shows a top view onto the winding holder according to FIG. 6.1;

FIG. 6.2 shows the twisting of the coil on the winding holder/twisting device;

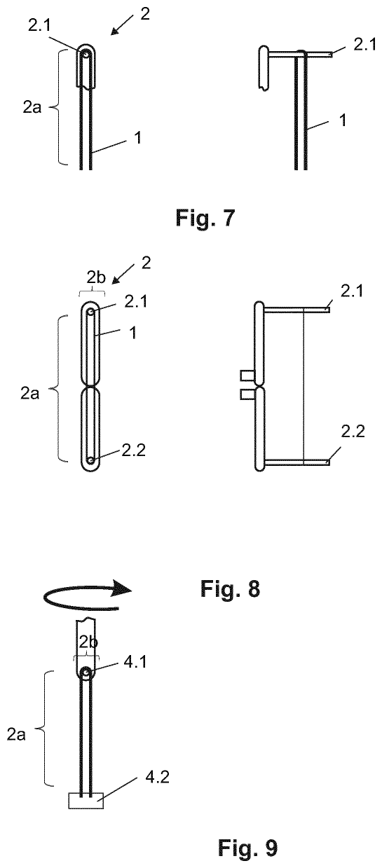

FIG. 7 shows a winding holder with one finger and a half-loop (top view/lateral view);

FIG. 8 shows a winding holder with two fingers and a ring (top view/lateral view);

FIG. 9 shows a twisting device with one finger, a tong tool, and a half-loop;

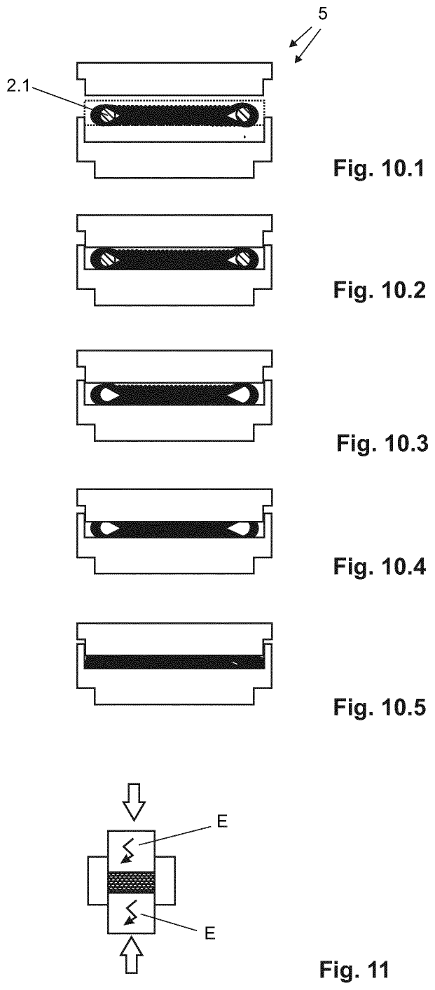

FIGS. 10.1-10.5 show the compacting of the twisted wire packet in a press;

FIG. 11 shows electrode welding of the head ends of the compressed strand for the electrical and mechanical connection of the wire sections disposed there.

The starting point of a method according to the invention for producing compressed strand is an insulated wire 1, preferably a varnish-insulated wire. It is an electrically conductive wire, preferably made of copper, aluminum or copper and/or aluminum alloys, respectively. The insulated wire can also have a further sheathing, for example, in the form of a bonding varnish. The insulated wire is typically present on a reel from which the wire is drawn and supplied to the production process as a wire supplied in a straight or substantially straight manner. This means that the wire is wound off a roll and is formed into the intended shape of the half-loop, ring, or coil only in the shaping process.

The result of the production process is a compressed strand F. The compressed strand comprises a first head end and a second head end. The head ends of the compressed strand (more precisely the wire sections located there) are electrically and mechanically interconnected, where this can be done with the aid of sleeves H1 or H2, respectively. A wire packet D is arranged between the head ends. The wire packet consists of a number of wires which are typically twisted together and, as a wire packet, are preferably enclosed by a main insulation layer. The compressed strand is additionally compacted and preferably has a rectangular or trapezoidal cross-sectional area.

A method according to the invention for producing compressed strand comprises at least the process steps of
shaping an insulated wire into at least one half-loop, ring, or coil on a shaping device 2
Optional, partially stripping insulation from the at least one half-loop, ring, or coil with an insulation stripping device 3
twisting the at least one half-loop, ring, or coil partially stripped of insulation into a wire packet using a twisting device 4
compacting the wire packet using a compacting device 5

A coil is to be understood to mean a spiral-shaped structure with several turns. The ends are typically not connected to each other. In principle, however, it is possible to connect the ends of the coil. The coil does not necessarily have to be circular, but the coil instead has a more rectangular shape with rounded corners. In this respect one can speak of two long sides 2a and two short sides 2b of the coil.

A ring is to be understood to mean a closed structure of a wire with the number of turns 1, i.e. the ends are connected to one another. The ring does not necessarily have to be circular, but the ring instead has a more rectangular shape with rounded corners. In this respect one can speak of two long sides 2a and two short sides 2b of the ring.

A half-loop is intended to mean a U-shaped structure that is open on one side. The wire does not describe a complete turn and the ends are not connected to each other. In this respect one can speak of two long sides 2a and one short side 2b of the half-loop.

The individual method steps shall be explained below:

### Shaping

Shaping takes place in a shaping device 2. So-called winding holders are conceivable as shaping devices.

In a simplest embodiment, the winding holder comprises a finger 2.1 over which the insulated wire is quasi placed and shaped into a half-loop. Several wires can be placed one after the other onto the finger and accordingly be shaped into several half-loops. The resulting half-loops can lie adjacent to one another and/or one above the other on the finger.

In a further embodiment, the winding holder can comprise two fingers 2.1, 2.2. The two fingers are aligned parallel or substantially parallel to one another and spaced from one another. One or more rings of the insulated wire can be pushed onto the winding holder. The rings can lie adjacent to one another and/or one above the other on the fingers.

In a further embodiment, the winding holder can comprise two fingers 2.1, 2.2 and an axis of rotation R. The axis of rotation is preferably arranged between the fingers and parallel to the fingers. This is essentially a kind of reel on which the insulated wire can be wound into a coil. The wires of the coil can be arranged next to one another and/or one above the other.

In a further embodiment, the winding holder can comprise four fingers 2.1 to 2.4. The four fingers are aligned parallel or substantially parallel to one another and spaced from one another. In a top view, the four fingers preferably form the corners of a rectangle or square. One or more rings of the insulated wire can be pushed onto the winding holder. The rings can lie adjacent to one another and/or one above the other on the fingers.

In a further embodiment, the winding holder can comprise four fingers 2.1 to 2.4 and an axis of rotation R. The four fingers are aligned parallel or substantially parallel to one another and spaced from one another. In a top view, the four fingers preferably form the corners of a rectangle or square. The axis of rotation is preferably arranged between the fingers, quasi at the center of the rectangle or square, and parallel to the fingers. This is essentially a kind of reel on which the insulated wire can be wound into a coil. The wires of the coil can be arranged next to one another and/or one above the other.

Basically, a variant with three or more fingers is also conceivable.

The result of the shaping process is the shaping of an insulated wire into at least one half-loop, ring, or coil.

### Stripping Insulation

The at least one half-loop, ring, or coil is partially stripped of insulation using an insulation stripping device 3. The insulated at least one half-loop, ring, or coil can be partially stripped of insulation mechanically or abrasively, in particular by grinding and/or sandblasting. Chemical and/or thermal methods, in particular using cold embrittlement, laser sublimation, induction heating, etc., are also conceivable. In principle, any method is conceivable there which enables the removal of the insulation of the wire. Partial stripping means that a section of the insulated wire extending in the longitudinal direction is freed from the insulation material, whereby “freeing” is to be understood in technically relevant categories. If the insulated wire is further coated with other components, such as bonding varnish, then this component is likewise removed. Essentially, it is crucial that an electrically conductive surface of the wire is exposed.

Insulated wire 1 is basically still held on respective shaping device 2 so that stripping insulation is basically possible on those sections of the at least one half-loop, ring, or coil that are exposed or, in other words, not in contact with a finger. Depending on the shaping device, preferred sections arise there that are to be or can be stripped of insulation, respectively.

In the case of the winding holder with one finger, the region of the half-loop immediately adjacent to the finger and at the end side of the half-loop can be considered.

In the case of the winding holder with two fingers, the regions of the coil or the rings directly adjacent to the fingers can be considered. Quasi the ends of long sides 2a are stripped of insulation.

In the case of the winding holder with four fingers, the regions of the coil or the rings between two fingers can be considered, preferably on the shorter sections of the coil or the rings if the fingers form, for example, the corners of a rectangle. Quasi the short sides are stripped of insulation.

The result of the insulation stripping method is a coil or rings or half-loops with partially stripped wires.

### Twisting

The coil or the rings or half-loops are twisted by way of a twisting device 4. The twisting device substantially comprises a first gripper 4.1 for the first distal end of the coil or the rings or half-loops, as well as a second gripper 4.2 for the second distal end of the coil or the rings or half-loops. The grippers are rotated approximately about the longitudinal axis of the coil or the rings or half-loops, so that the wires are twisted.

In a first embodiment of the twisting device, the first gripper is formed by a finger and the second gripper is formed by a tong tool. This twisting device is preferably suitable for twisting half-loops. The tong tool grips the free ends of the half-loops while the finger grips the short sides of the half-loops. To this end, the first finger of the twisting device can also be the first finger of the shaping device. In this case, the shaping device can be equipped with an additional mechanism that enables the finger and the tong tool to be rotated against one another.

In a first embodiment of the twisting device, the first gripper is formed by a first finger and the second gripper is formed by a second finger. This twisting device is preferably suitable for twisting the coil or the rings. The fingers grip the respective distal coil ends or ring ends, respectively, i.e. the short sides. To this end, the first finger of the twisting device can also be the first finger and/or the second finger of the twisting device can be the second finger of the shaping device, respectively. In this case, the shaping device can be equipped with an additional mechanism that enables the fingers to be rotated against one another.

If the shaping device is equipped with four fingers, then the rings or the coil wound thereon can be transferred to a twisting device with two fingers. Twisting is then preferably done using this twisting device. In this regard, reference can be made to the explanations provided above.

The result of the twisting process is a twisted wire packet.

### Compacting

Compacting takes place in a compacting device 5, in particular a press.

The twisted wire packet is pressed in a compacting process into a compressed strand F. The preceding method steps ensure that the respective distal ends of the twisted wire packet are stripped of insulation. If the ends still contain partially insulated wire, they can be cut off, but do not necessarily need to be.

The result of the compacting process is a compressed strand F.

The end sections of the compressed strands can then be electrically and mechanically connected to one another in a further process step. FIG. 11 shows an electrode welding process with two welding electrodes E in which the wire sections of the head ends are electrically and mechanically interconnected. A sleeve is not absolutely necessary in the case of head sections already stripped of insulation.

### Alternative Process

It is preferably provided in the process outlined above that shaping is carried out before the insulation is stripped. It can be provided in an alternative embodiment of the method that the insulation is stripped prior to shaping (cf. in particular FIGS. 6 and 7). For the remainder, reference can substantially be made to the features already outlined above.

An insulated wire preferably supplied from a reel is there first partially stripped of insulation using an insulation stripping device in order to then be shaped by a shaping device into at least one half-loop, ring, or coil. A rotatable two-finger winding holder is preferably conceivable as the shaping device. The synchronization of stripping the insulation to the winding holder is preferably carried out in such a way that the regions of the wire stripped of insulation rest in the region of the fingers. If the shaping device is also configured as a twisting device, then the resulting at least one ring or coil can remain on the fingers and be twisted directly.

There as well, the result is a twisted wire packet that can be supplied to the subsequent method step, in particular to compacting.

The production process for producing compressed strand from insulated wire is preferably carried out as follows (cf. in particular FIGS. 4 and 10).

Insulated wire is wound into a coil on a two-finger winding holder with an axis of rotation R as the shaping device. The wires of the coil are preferably all disposed adjacent to one another.

Sections of the coil immediately adjacent to the fingers are stripped of the insulation using a laser as an insulation stripping device.

The shaping device also comprises the twisting device so that the wire wound between the fingers, i.e. the coil, can be twisted directly.

The wire packet is inserted into the compacting device together with sleeves and pressed.

The result is a compressed strand with a cross-sectional shape that is predetermined by the mold of the press. The end sections of the compressed strands are then electrically and mechanically interconnected by electrode welding. An electrical contact is accordingly created between the ends of the wire packet that have been stripped of insulation in this region.

A further preferred production process for producing compressed strand from insulated wire is carried out as follows (cf. in particular FIGS. 5 and 10).

Insulated wire is wound into a coil on a four-finger winding holder with an axis of rotation R as the shaping device. The wires of the coil are preferably all disposed adjacent to one another.

Sections of the coil immediately between two fingers are stripped of the insulation using a laser as an insulation stripping device. Quasi the short sides are stripped of insulation.

The coil is transferred from the four-finger winding holder to a two-finger twisting device.

The coil is twisted into a wire packet in the two-finger twisting device.

The wire packet is inserted into the compacting device and pressed. The end sections of the compressed strands are then electrically and mechanically interconnected by electrode welding.

### Additional Method Steps/Further Aspects of the Invention

Additional, but not exhaustively listed, method steps can be, for example, the application of bonding varnish or the application of a main insulation layer around the compressed strand, e.g. by extrusion.

The object of the bonding varnish is to mechanically affix the individual wires to each other. This applies in particular for vibrations that occur when alternating current flows through. When heated and/or pressed, the bonding varnish becomes viscous and glues the individual wire layers together, cf. in this regard e.g. DE102015201711A1 Instead of a double layer (insulation+bonding varnish), a combination material known to the person skilled in the art can also be used. The partial removal of the bonding varnish is also to be covered by the production step “partially stripping insulation”.

Compressed strands of a higher order can also be produced. This means that strands are twisted with strands to form a new strand (of a higher order). This can be accomplished as part of the “twisting” method step.

The shaping device, the insulation stripping device, and/or the twisting device are preferably combined to one assembly. In particular the fingers can have different functions (winding, twisting, . . . ). Of course, the devices can also be configured separately.

The configurations are generally not limited to the production of compressed strands with sleeves. The configurations can also be used on compressed strands without sleeves.

As already explained above, the compressed strand produced according to the invention is advantageously suitable for producing an electric motor, in particular its stator S. Accordingly, the advantages of the compressed strand production method according to the invention can be used for producing an electric motor, in particular its stator. A stator S of an electric motor is shown by way of example in FIGS. 1 to 3.

The compressed strand produced according to the invention can there preferably be used in the stator S of an electric motor.

Methods or uses of the kind described above are employed in the production of electric motors, in particular in vehicles.

### LIST OF REFERENCE CHARACTERS

The following reference characters are used in the figures:
E welding electrodes
F compressed strand
H1 sleeve/head end
H2 sleeve/head end
D wire packet
S stator
R axis of rotation
1 insulated wire
1′ wire partially stripped of insulation
2 shaping device, in particular winding holder
2.1 first finger
2.2 second finger
2.3 third finger
2.4 fourth finger
2a long side
2b short side
3 insulation stripping device, in particular laser
4 twisting device
4.1 first gripper
4.2 second gripper
5 compacting device, in particular press

1. Method for producing a compressed strand from an insulated wire supplied in a straight or substantially straight manner, comprising the following method steps:
a) shaping said insulated wire into at least one half-loop, ring or coil using a shaping device;
b) twisting said at least one half-loop, ring, or coil into a wire packet using a twisting device;
c) compacting said wire package using a compacting device,
wherein said wire or said half-loop, ring or coil is partially stripped of insulation using an insulation stripping device, where said partial stripping of insulation is performed after shaping and prior to shaping, or said partial stripping of insulation is performed prior to shaping.

2. Method according to claim 1, wherein said shaping is performed in a shaping device configured as a winding holder, wherein
said winding holder comprises a finger over which said insulated wire is placed and shaped into a half-loop that has a short side and two long sides.

3. Method according to claim 1, wherein said partial stripping of insulation is performed after shaping and prior to shaping on said long sides or on said short sides between said fingers of a winding holder, or said partial stripping of insulation is performed prior to shaping on said insulated wire supplied in a straight or substantially straight manner.

4. Method according to claim 1, characterized in that partially stripping insulation can be done mechanically and/or abrasively, in particular by grinding and/or sandblasting, and/or chemically and/or thermally, in particular using cold embrittlement, laser sublimation, induction heating.

5. Method according to claim 1, characterized in that twisting said at least one half-loop, ring, or coil is performed using a twisting device, where said twisting device comprises in particular a first gripper for the first distal end of said at least one half-loop, ring, or coil, and comprises in particular a second gripper for the second distal end of said at least one half-loop, ring, or coil, where said grippers are rotated in particular about or approximately about the longitudinal axis of said at least one half-loop, ring, or coil.

6. Method according to claim 1, characterized in that said first gripper is formed by a first finger and said second gripper by a second finger or a tong tool.

7. Method according to claim 1, characterized in that said twisting device is integrated into said shaping device or said twisting is performed in said shaping device, respectively.

8. Method according to claim 1, characterized in that said insulated wire and/or the wire packet is acted upon with a bonding varnish, at least in sections.

9. Method according to claim 1, characterized in that the wire sections stripped of insulation are mechanically and electrically connected to one another after shaping, where the connection of said wire sections stripped of insulation is in the head ends is effected in particular without sleeves.

10. Method for producing an electric motor, comprising a stator, where the winding in said stator is formed at least in sections by compressed strand, characterized in that said compressed strand was produced at least in sections using the method according to claim 1.

11. (canceled)

12. Compressed strand produced according to claim 1, characterized in that at least one head end comprises loops that are not severed.

13. Method according to claim 1, wherein said shaping is performed in a shaping device configured as a winding holder, wherein
said winding holder comprises two fingers, where said fingers are aligned parallel or substantially parallel to one another and spaced from one another, where at least one ring of said insulated wire is pushed onto said winding holder and has two short sides and two long sides bearing against said fingers.

14. Method according to claim 1, wherein said shaping is performed in a shaping device configured as a winding holder, wherein
said winding holder comprises two fingers and an axis of rotation, where said fingers are aligned parallel or substantially parallel to one another and spaced from one another, where said insulated wire is wound to a coil on said winding holder and has two short sides and two long sides bearing against said fingers.

15. Method according to claim 1, wherein said shaping is performed in a shaping device configured as a winding holder, wherein
said winding holder comprises four fingers, where said fingers are aligned parallel or substantially parallel to one another and spaced from one another, where at least one ring of said insulated wire is pushed onto said winding holder and has two short sides and two long sides arranged between said fingers.

16. Method according to claim 1, wherein said shaping is performed in a shaping device configured as a winding holder, wherein
said winding holder comprises four fingers and an axis of rotation, where said fingers are aligned parallel or substantially parallel to one another and spaced from one another, where said insulated wire is wound into a coil on said winding holder and has two short sides arranged between said respective fingers and two long sides arranged between said fingers.
